(19) United States
(12) Patent Application Publication
(10) Pub. No.: US 2021/0262639 A1
(43) Pub. Date: Aug. 26, 2021

(54) LINEAR LENS VARIETIES TO PROVIDE QUADRILATERAL ILLUMINATION

(71) Applicant: Ercan ARSLAN, Antalya (TR)

(72) Inventor: Ercan ARSLAN, Antalya (TR)

(21) Appl. No.: 17/053,824

(22) PCT Filed: Aug. 9, 2018
(86) PCT No.: PCT/TR2018/050426

§ 371 Date: Nov. 9, 2020

(30) Foreign Application Priority Data
May 9, 2018 (TR) 2018/06944

(51) Int. Cl. F21V 13/04; G02B 3/00; F21V 3/02; F21V 19/00

(52) U.S. Cl. CPC F21V 13/04; F21V 19/001; F21V 3/02; G02B 3/0087

(57) ABSTRACT

A Non-imaging Optic Design technique to build linear lens types designed with Total Internal Reflection-TIR and FreeForm structure combinations in its body and consisting biaxial optical and physical structure thanks to its TIR and FreeForm forms on its axes and having biaxial light beam with creating narrow angle by a TIR structure in its width-axes and more wider angle by a TIR or FreeForm structure in its longitudinal-axes to provide rectangular lighting, enable the most appropriate modular merging thanks to the advantages ensured by the rectangular form of the illumination with homogeneous light distribution and prove that the continuous homogeneous light distribution over the target illumination area take the rectangular shape of the target area with highest flux efficiency from a single positional point.

### TECHNICAL AREA

The invention is; developed for illuminating over all quadrilateral target areas that requires artificial illumination, optimally transfer of the light flux extracted by the light sources stated in the lighting fixtures with LED to the targeted illumination area, based on “Non-imaging optics” which is the transfer of optimal light flux from the light source to the targeted area, using the common Total Internal Reflection (TIR) and FreeForm optical techniques in its optical design and able to achieve linear quadrilateral lighting with its biaxial light beams with cut-off angles which are about secondary optical linear lens varieties.

The invention is, able to create light beams with cut-off solid angles, designed with Total Internal Reflection-TIR techniques in its optical design, capable of creating quadrilateral linear light spottings with sharp boundary lines over a targeted illumination area by its biaxial light beams with cut-off angles, able to achieve linear quadrilateral illumination, able to create uniform linear flux distribution within the boundaries of the linear quadrilateral light spotting, allowing optimal modular combinations thanks to the sharp geometrical boundary advantages of the light spottings and introducing new quality feature as “continuous lighting” term for not allowing weak light intensity between merging sides, besides, eliminating the directional glaring problem caused by light source in the lighting thanks to its biaxial light beams with cut-off angles which preventing the outside scattering, capable of providing higher flux usage efficiency relative to its counterparts by directing the light flux from the light source into the target illumination area and also protecting the environment from light pollution thanks to high flux efficiency with non-outside scattering, designed based on the Non-imaging optical design to get optimal light flux transfer, which are about new generation optical lens varieties

Former Techniques

Nowadays, secondary optic lenses are used to direct the light flux extracted by the LEDs which used as sources in artificial LED lighting to the target lighting area and these lenses are designed with the Total Internal Reflection-TIR, unconstrained FreeForm and Fresnel techniques for optical designs. The types of lenses that are available nowadays are classified with their design techniques used for, such as TIR Lens, Free Form Lens and Fresnel Lens.

In addition to these, lenses that operate with simple, inefficient imaging optics for lighting are also used in artificial lighting. However, the lenses which are based on imaging optical design operate at very low efficiency due to their simple imaging optical structure. These lens types, which are designed basically image optic structure, fail in transferring flux to the target, since they only can transfer the chip image of the light source (LED) and the large amount of multidirectional light emission cannot be collected in optical body.

Total Internal Reflection-TIR Lens, one of the available lens types, has higher efficiency than other lens varieties. Based on Total Internal Reflection (TIR) rules and light emission from source towards target optimally (Non-imaging optics), TIR Lenses are the most efficient optical lens type in the world for “light flux transfer to the target illumination area”. Besides these high efficiencies, TIR Lenses are able to create certain and very smooth light beams. In addition, a Total Internal Reflectance-TIR Lens designed with the advantages of TIR technology has the distinctive ability to have a very sharp cut-off solid angle. Using lenses with cut-off solid angle light beams, the lighting areas can be illuminated very well within marked boundaries and geometrical shapes. Because of these advantageous features, TIR Lenses are the most preferred lens type for illumination.

In addition, due to the optical design constraints for TIR lens types, TIR Lenses cannot create wider angles light beams. Nowadays, in cases where a wider angle light beam required, the FreeForm lens type is used instead of the TIR Lens type to produce a wider angle light beams.

FreeForm type, is a technique not based on a specific rule, provides broader optical design opportunities for the designer, allows optical designs to be made at any angle beside wider angles and especially allows smaller lens designs for LEDs with multiple chipping indexes and large Light Emission Surface (LES).

In addition to these features, FreeForm lenses are less efficient than TIR Lenses in light transfer from the source to the target area. However, in the current state, although they are less efficient than the TIR lenses, the FreeForm lenses are necessarily preferred for illumination requiring wider angles, such as road lighting.

On the other hand, the Fresnel is another lens type that is used nowadays in cases where efficiency is not considered in LED illuminations. Fresnel lens type, used for create light beams at linear angle. Fresnel lenses have a very large optical surface area compared to their counterparts and optical efficiency is low because of large diffraction and reflections occur on large optical surfaces. However, such lenses are sometimes used because of their ability to emit linear light beam in decorative lighting that does not require efficiency.

On the other hand, in the present day, the types of lenses used in artificial illumination are preferred according to their efficiency and beam angles as well as the capabilities of the light beams they have.

In this context, lenses that create light beams that can create a light spotting (a trail of light flux falling in the target area) that will take the geometric shape of the illumination area are preferred in order to create a more uniform and covering illumination over the target illumination area.

Today however, with existing lens types, light spottings can often be created in circular and elliptical geometries. It is impossible to illuminate areas in quadrilateral form according to their geometric shapes with only using light spottings with circular and elliptical geometries. It is physically impossible for multiple light spottings which are circular or elliptical, to be able to cover-illuminate an area with a modular combination without leaving intermediate spaces. For example, in road lighting, it is impossible to cover an illumination area that will take the shape of a road's linear quadrilateral (rectangle) shape with circular or elliptical shaped light spots.

Another important problem experienced in the current situation is the photometric standard of LED illumination which we regard as the next generation illumination has not been constituted yet and this requirements of new standards have been tried solved by the old traditional lighting standards. With this constrains, the opportunity for high flux transfer efficiency supplied by the LED lighting could not be benefitted. However, the Flux Transfer Efficiency of the LED Illumination is very high in terms of the suitability in the directional lighting and another benefit is better uniform light distribution. This high efficiency and uniformity of light distribution supplied by the LED illumination is wasted as result of the application of old traditional lighting standards for the new generation illumination.

In the present case, it also affects optical designs as an imposition that the old traditional photometric standards are still followed. As a result of this imposition, the mistake of making and using optical designs that meet the old photometric standards are still going on.

Particularly nowadays, for the next generation of LED lighting applications in road lighting, optical designs have being made to meet the same photometric standards as in traditional lighting and old photometric standard applications are still ongoing.

Content of old existing standards are still be followed and these standards not related to a lighting that will cover the geometric shape of the target illumination area and there is not a rule that considers high flux transfer onto the target area. This validation of old standards makes new generation lighting inefficient and inferior.

In the present case, the old traditional photometric standards are still being used for the new generation LED lighting; photometrically similar light beams are still being created and the same old illumination photometric emission structure is maintained. Unfortunately for this reason, the gain from the new generation illumination is limited only by the difference in Light Creating Efficiency (lumen/watt). Light Creating Efficiency difference is the lumen percentage difference that produces light per unit power relative to other conventional light sources, which originate from the light source LEDs.

### Aim of the Invention

The intended purpose of this invention is; to create new generation of lens types which are able to illuminate the target areas in accordance with its geometric shapes, to be able to cover and illuminate areas, in particular the linear quadrilateral form of target lighting areas with light flux created from single point position, to have cut-off solid angle light beams and thanks to these light beams, illuminate the quadrilateral target illumination areas with a homogeneous dissipated intensity within its boundaries, minimizing the directional glaring problem with determination of sharp boundary lines, also protecting the environment from light pollution with this feature, providing a uniform and continuous integrated illumination without leaving a low light interval thanks to modular combination of multiple illuminated areas in a quadrilateral structure, to provide high efficiency light flux transfer to the target illumination area, again with this feature, providing high flux utilization efficiency and able to create linear quadrilateral lighting at any scale from a single point position.

In order to accomplish the purpose of the invention, it is intended to provide the best features of the known TIR Lens and FreeForm Lens into a single lens body. Using this design of unit body which has these superior features, we can create new generation lens varieties. In the invention, two new lens types were created with the ability to meet the needs in lighting mentioned in the purpose of invention by merging useful features of TIR and FreeForm lenses in a single body.

### Detailed Explanation of the Invention

The subject of the invention is two new lens types which are distinguished from each other according to maximum width in the longitudinal axes of their biaxial angled light beams; the basic feature that they can be distinguished from each other is the wide angle they can create in the longitudinal axes.

Linear TIR Lens Type:

For the first lens type mentioned above, the optical design of lens body structure in both axes are made according to Total Internal Reflection (TIR) rules, the biaxial light beam of the first lens type creates narrow angle in its width-axis, while its longitudinal-axis angle can reach a limited maximum width. According to the optical laws, the physical structure that first lens type can take is a narrower TIR structure in its width-axis, a larger TIR structure in its longitudinal-axis and because of the structures in the two axes it has linear appearance; named as “Linear TIR Lens”

The first lens type in the invention, named Linear TIR Lens, has the ability of high Flux Transfer Efficiency while transferring light flux from the light source to the target area because the use of Non-imaging optics technique and TIR design rules in its optical design

Total Internal Reflectance-TIR structures in the Linear TIR Lens able to create cut-off solid angle in its both axes; thanks to created cut-off solid angles in its both axes, advanced lens designs could be made and these designs are able to create linear homogenous quadrilateral lighting with sharp boundary lines over target area from a single point position, these designs are able to minimize directional glaring problem with determining of sharp boundary lines, also capable of protecting the environment from light pollution with this feature, providing a uniform and continuous integrated illumination without leaving a low light interval thanks to modular combination of multiple illuminated areas in a quadrilateral structure,

The Linear TIR Lens referred in the invention has the form of narrow Total Internal Reflection (TIR) structure in its width-axes, and wider Total Internal Reflection (TIR) structure in its longitudinal-axes; linear TIR Lens has formed with merging of TIR structures in width and longitudinal-axes surfaces continuously without losing their optical functions to become unit body.

Linear TIR Lenses, because of their linear optic form, have biaxial light beam which has narrow angled in its width-axes and wider angled in its longitudinal-axes for linear quadrilateral lighting. Because of that, Linear TIR Lenses are able to create sharply bounded linear quadrilateral lighting from a single point position. Linear TIR Lenses illuminate the width of the linear quadrilateral target illumination area with narrow angles in width-axes, also illuminates length of the linear quadrilateral target illumination area with wide angles in longitudinal-axes.

Operating Principle of Linear TIR Lens:

The path of ray vectors (photons) in width-axes angle of Linear TIR Lens occur in the TIR structure in the width-axes of the lens body; ray vectors emitted by the source are refracted (transition from less dense to more dense medium) inwardly from the lateral width-axes side collectors where bottom face of lens body with respect to light source, ray vectors are reflected internally from the surfaces in the lateral width TIR body with the Total Internal Reflection rules, making a cut-off angle with outward diffraction (transition from dense medium to less dense) through the lateral width exit surfaces of the TIR structure in the width-axes, at the same time tracing the longitudinal-axes too and addressed to target quadrilateral illumination area.

In a similar way, the path of ray vectors in longitudinal-axes angle of Linear TIR Lens occur in the TIR structure in the longitudinal-axes of the lens body; ray vectors emitted by the source are refracted (transition from less dense to more dense medium) inwardly from the lateral longitudinal-axes side collectors where bottom face of lens body with respect to light source, ray vectors are reflected internally from the surfaces in the lateral longitudinal TIR body with the Total Internal Reflection rules, making a cut-off angle with outward diffraction through the lateral longitudinal exit surfaces of the TIR structure in the longitudinal-axes, at the same time tracing the width-axes too and addressed to target quadrilateral illumination area.

Also, the path of ray vectors which are tracing both width and longitudinal-axes angle of Linear TIR Lens occur at the center structure of the lens' body; ray vectors emitted by the source are refracted from inwardly from the center bottom collectors where bottom face of lens body with respect to light source, reach directly to central exit surface of the lens body with the inward refracted angles and guided to the target linear quadrilateral illumination area both in the width-axes and in the longitudinal-axes by the outward diffracted angles.

FreeForm Lens Type:

Because of optical designs of TIR lenses made according to Total Internal Reflection rules, the maximum angle width of a Linear TIR Lens is limited. In this reason, the FreeForm Lens structure which produces a wider angle in the longitudinal-axes than the TIR structure has been used in linear applications (e.g. road lighting) that require a wider-axis. Therefore a new kind of hybrid lens has created which has a FreeForm structure in longitudinal-axes with TIR structure in the width-axes.

The Hybrid Lens type is derived from the Linear TIR Lens type to produce wider angled longitudinal-axes; while Hybrid Lens structure is the same as the TIR form of the Linear TIR Lens type in the width-axes, its structure only in the longitudinal-axes is formed by FreeForm type that evolved from TIR structure.

New Hybrid Lens which is derived from Linear TIR Lens type has narrow TIR structure in its narrow angle requiring width-axes and wide FreeForm structure in its wider longitudinal-axes; with this feature, invention takes a linear appearance and forms a new kind of lens type as named “Linear Hybrid Lens”

Linear Hybrid Lens type, derived from Linear TIR Lens, formed with TIR structure surfaces in its width-axes and FreeForm structure surfaces in its longitudinal-axes merging in continuously without losing their optical functions to become unit body.

The optical design of the Linear Hybrid Lens type is based on Non-imaging optics technique which is the transfer of optimal light transfer from the light source to the targeted area. Also because of its width-axes structure is based on Total Internal Reflection-TIR rules, its ability to transfer light flux to target illumination area is high and has high Flux Transfer Efficiency.

Linear Hybrid Lens type, thanks to its width-axes structure which is based on TIR rules, is able to create cut-off solid angle in its light beam in its width-axes, is able to create linear quadrilateral lighting with sharp width boundary lines over target area from a single point position homogeneously, minimizes the directional glaring problem with determination of sharp boundary lines, also protects the environment from light pollution with this feature, provides a uniform and continuous integrated illumination without leaving a low light interval thanks to modular combination of multiple illuminated areas in a quadrilateral structure.

With using new generation Linear Hybrid Lens type which evolved from Linear TIR Lens and formed by TIR and FreeForm structures, much extended linear quadrilateral lighting areas (e.g. for road lighting) could be illuminated. The new generation Linear Hybrid Lens type mentioned here is able to create biaxial light beams with narrow angle in its width-axes and much wider angle in its longitudinal-axes, thus it becomes possible to cover a much longer quadrilateral illumination area from a single point position. New generation Hybrid Lenses illuminate the width of the quadrilateral illumination area with narrow angles in the width-axes and illuminate the length of the quadrilateral illumination area with wide angles in the longitudinal-axes.

Operating Principle of FreeForm Lens:

The path of ray vectors (photons) in the width-axes angle of Linear Hybrid Lens occur in the TIR structure in the width-axes of the lens body; ray vectors emitted by the source are refracted (transition from less dense to more dense medium) inwardly from the lateral side collectors into TIR body, reflected internally from the surfaces in the lateral TIR body with the Total Internal Reflection rules, create a cut-off angle with outward diffraction (transition from dense medium to less dense) through the lateral exit surfaces at the same time tracing longitudinal-axes, guided with the high flux to the target linear quadrilateral illumination area.

Again, The path of ray vectors in longitudinal-axes angle of Linear Hybrid Lens which occur in the FreeForm center structure in the longitudinal-axes of the lens body; ray vectors emitted by the source are refracted inwardly from the central collectors with respect to the light source, reaching the exit surface of the FreeForm lens directly with the inward refracting angles in the body, creating wider angle with outward diffraction angles in the longitudinal-axes, at the same time tracing the width-axes, guided with the high flux to the target linear quadrilateral illumination area.

The most important feature of the new generation linear lenses, Linear TIR Lens and Linear Hybrid Lens, is that they can make the linear quadrilateral illumination from a single point position.

### DETAILED DESCRIPTION OF THE INVENTION

The invention is about artificial illumination over all quadrilateral target areas, and also about optimally transferring of the light flux created by the LED light sources to the targeted illumination area based on Non-imaging-optics technique which is the transfer of optimal light flux from the light source to the targeted area, using the Total Internal Reflection (TIR) and FreeForm optical techniques in its optical design and able to achieve linear quadrilateral lighting with their biaxial light beams with cut-off angles which are about secondary optical linear lens varieties.

The invention is, able to create light beams with cut-off solid angles with using Total Internal Reflection-TIR techniques in its optical design, capable of creating linear quadrilateral light spottings with sharp boundary lines over a targeted illumination area by its biaxial light beams with cut-off angles, able to achieve linear quadrilateral illumination, able to create uniform light intention distribution within the boundaries of the linear quadrilateral light spotting, allowing optimal modular combinations of the light spottings thanks to the sharp geometrical boundary feature and providing a uniform and continuous integrated illumination without leaving a low light interval between merging edges, besides, eliminating the directional glaring problem caused from light source thanks to its biaxial light beams with cut-off angles which preventing the outside scattering, operating based on the Non-imaging optical design to get optimal light flux transfer from source to target area, in this way, capable of providing higher flux usage efficiency relative to its counterparts by directing the light flux from the light source only into the required target illumination area and also protecting the environment from light pollution thanks to high flux efficiency with non-outside scattering; about new generation optical lens varieties.

The invention is only explained in detail by means of sampling with hereinafter referring to drawings annexed;

### FIGURES TO HELP UNDERSTANDING THE INVENTION

FIG. 1; Unit Body in Perspective and Quarter Cross Sectional Form View Drawings of the Linear TIR Lens Type

FIG. 2; Path view of The Ray Vectors in the TIR structures of the Linear TIR Lens type in its both width and longitudinal axes with its axial cross sectional structure views.

FIG. 3; Unit Body in Perspective and Quarter Cross Sectional Form View Drawings of the Linear Hybrid Lens Type

FIG. 4; Path view of the Ray Vectors in the TIR structure of the Linear Hybrid Lens type in its width axes and the FreeForm structure of the Linear Hybrid Lens type in its longitudinal-axes with its axial cross sectional structure views.

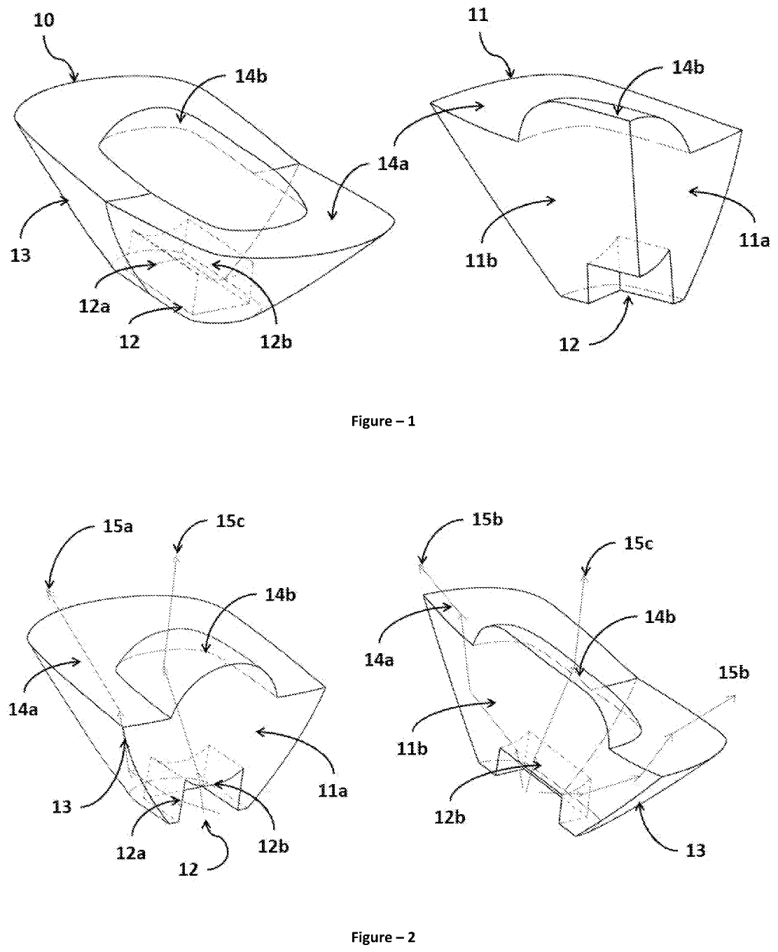

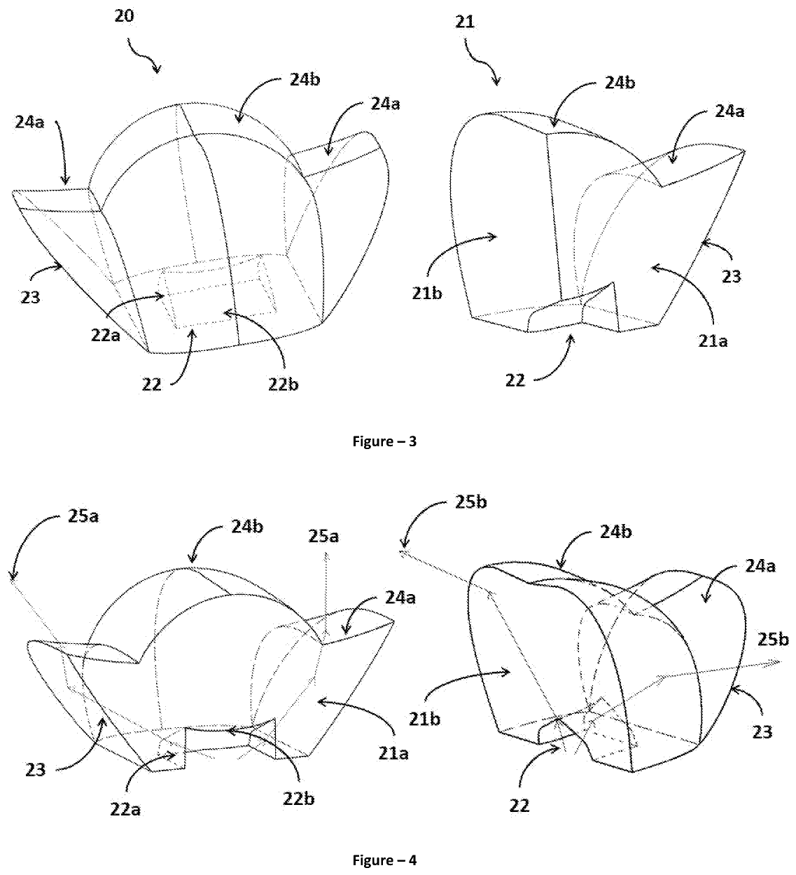

### DEFINITION OF THE REFERENCES

10. Linear TIR Lens
11. Linear TIR Lens Type Quarter Cross Section
11a. Linear TIR Lens Type Width-axes Cross Section
11b. Linear TIR Lens Type Longitudinal-axes Cross Section
12. Linear TIR Lens Type Ray Collector Surfaces
12a. Linear TIR Lens Type Ray Collector Lateral Surfaces
12b. Linear TIR Lens Type Ray Collector Central Surfaces
13. Linear TIR Lens Type Side Surface in Lateral TIR Structure
14a. Linear TIR Lens Type Ray Diffraction Surface in Lateral TIR Structure
14b. Linear TIR Lens Type Ray Diffraction Central Surfaces
15a. Ray Vectors Path in Lateral TIR Structure in Width-axes
15b. Ray Vectors Path in Lateral TIR Structure in Longitudinal-axes
15c. Ray Vectors Path Refracted from Center Collector Surface to Ray Diffraction Central Surface
20. Linear Hybrid Lens
21. Linear Hybrid Lens Type Quarter Cross Section
21a. Linear Hybrid Lens Type Width-axes Cross Section
21b. Linear Hybrid Lens Type Longitudinal-axes FreeForm Structure Cross Section
22. Linear Hybrid Lens Type Ray Collector Surfaces
22a. Linear Hybrid Lens Type Ray Collector Lateral Surfaces
22b. Linear Hybrid Lens Type Ray Collector Central Surfaces
23. Linear Hybrid Lens Type Side Surface in Lateral TIR Structure
24a. Linear Hybrid Lens Type Ray Diffraction Surface in Width-axes TIR Structure
24b. Linear Hybrid Lens Type Ray Diffraction Surfaces in FreeForm Structure in Longitudinal-axes
25a. Ray Vectors Path in Lateral TIR Structure in Width-axes
25b. Ray Vectors Path in FreeForm Structure in Longitudinal-axes

The invention is about, artificial LED illumination, operating with high Light Flux Transfer Efficiency, consisting biaxial optical and physical structure, having biaxial light beam with creating narrow angle in width-axes and more wider angle in longitudinal-axes, providing continuous homogeneous light distribution over the target illumination area according to get the shape of target area, a new generation Linear TIR Lens (10) features composed with; TIR structure surfaces in its width and longitudinal-axes merging in continuously without losing their optical functions to become unit body. The Linear TIR Lens type consists of; Linear TIR Lens Type Quarter Cross Section (11), Linear TIR Lens Type Width-axes Cross Section (11a), Linear TIR Lens Type Longitudinal-axes Cross Section (11b), Linear TIR Lens Type Ray Collector Surfaces (12), Linear TIR Lens Type Ray Collector Lateral Surfaces (12a), Linear TIR Lens Type Ray Collector Central Surfaces (12b), Linear TIR Lens Type Side Surface in Lateral TIR Structure (13), Linear TIR Lens Type Ray Diffraction Surface in Lateral TIR Structure (14a), Linear TIR Lens Type Ray Diffraction Central Surfaces (14b), Ray Vectors Path in Lateral TIR Structure in Width-axes (15a), Ray Vectors Path in Lateral TIR Structure in Longitudinal-axes (15b), Ray Vectors Path Refracted from Center Collector Surface to Ray Diffraction Central Surface (15c) and again, Linear Hybrid Lens (20) with TIR structure surfaces in its width-axes and FreeForm structure surfaces in its longitudinal-axes merging in continuously without losing their optical functions to become unit body. The Linear TIR Lens type consists of; Linear Hybrid Lens Type Quarter Cross Section (21), Linear Hybrid Lens Type Width-axes Cross Section (21a), Linear Hybrid Lens Type Longitudinal-axes FreeForm Structure Cross Section (21b), Linear Hybrid Lens Type Ray Collector Surfaces (22), Linear Hybrid Lens Type Ray Collector Lateral Surfaces (22a), (Linear Hybrid Lens Type Ray Collector Central Surfaces 22b), Linear Hybrid Lens Type Side Surface in Lateral TIR Structure (23), Linear Hybrid Lens Type Ray Diffraction Surface in Width-axes TIR Structure (24a), Linear Hybrid Lens Type Ray Diffraction Surfaces in FreeForm Structure in Longitudinal-axes (24b), Ray Vectors Path in Lateral TIR Structure in Width-axes (25a), Ray Vectors Path in FreeForm Structure in Longitudinal-axes (25b).

The invention is, able to create light beams with cut-off solid angles with using Total Internal Reflection-TIR techniques in its optical design, capable of creating linear quadrilateral light spottings with sharp boundary lines over the illumination area by its biaxial light beams with cut-off angles, able to achieve linear quadrilateral illumination, able to create uniform light intention distribution within the boundaries of the linear quadrilateral light spotting. Also the invention allows optimal modular combinations of the light spottings thanks to the sharp geometrical boundary feature and introduces new quality feature as “continuous lighting” term for not allowing weak light intensity between merging sides; besides, eliminates the directional glaring problem caused from light source thanks to its biaxial light beams with cut-off angles which prevents the outside scattering, is capable of providing higher Flux Usage Efficiency relative to its counterparts by directing the light flux from the light source into the target illumination area and also protects the environment from light pollution thanks to high flux efficiency with non-outside scattering, designed based on the Non-imaging optical design technique to get optimal light flux transfer, formed with merging of TIR structure faces in width and longitudinal-axes continuously without losing their optical functions to become unit body. The explained invention here is about the Linear TIR Lens (10) taking linear physical form because of a narrow structure in width-axes and larger structure in the longitudinal-axes; merging with TIR structure surfaces in the width-axes and FreeForm structure surfaces in the longitudinal-axes continuously without losing their optical functions to become unit body, the Linear Hybrid Lens (20) taking linear physical form because narrower structure in the width-axes, a larger structure in the longitudinal-axes.

The most important feature of the new generation Linear TIR Lens (10) and Linear Hybrid Lens (20) of the invention is that they can make the linear quadrilateral illumination from a single point position. They are also able to trace the longitudinal-axes while making angle in the width axes and trace width-axes while making angle in the longitudinal-axes.

Operating Principle of Linear TIR Lens:

Ray Vectors Path in Lateral TIR Structure in the Width-axes (15a) occurs in the Width-axes of Linear TIR Lens' TIR structure, creates the narrow angle of the biaxial light beam the Linear TIR Lens (10) has, rays emitted by the light source refracted to (transition from less dense to dense medium) lateral TIR structure inwardly from the Linear TIR Lens Type Ray Collector Lateral Surfaces (12a) in width-axes, reflected from Linear TIR Lens Type Side Surface in Lateral TIR Structure (13) by making the Total Internal Reflection rules in the body, with diffraction (transition from dense medium to less dense) angles in the Width-axes from Linear TIR Lens Type Ray Diffraction Surface in Lateral TIR Structure (14a) addressed to target quadrilateral illumination area, as well as tracing the longitudinal-axes of Linear TIR Lens (10) angle too.

Also, the path of ray vectors in the center structure of the Linear TIR Lens (10), rays from the light source are refracted inwardly from the Collector Central Surfaces (12b) at bottom face with respect to light source into the lens' body, then reach directly to Linear TIR Lens Type Ray Diffraction Central Surfaces (14b) and from Linear TIR Lens Type Ray Diffraction Central Surfaces (14b) diffracted to the target linear quadrilateral illumination area by tracing both width and longitudinal-axes angle of the biaxial light beam of the Linear TIR Lens (10).

Linear TIR Lens (10) creating a narrow cut-off solid angle in its TIR structure in the width-axes and creating wider cut-off angle in the longitudinal-axes, while creating cut off solid angle in the width-axes also tracing the light beam in the longitudinal-axes and because of this feature switches continuously to the longitudinal-axes cut-off solid angle, with the same way, while creating wider cut off solid angle in the longitudinal-axes also tracing the light beam in the width-axes and with this feature switches continuously to the width-axes cut-off solid angle.

Linear TIR Lens (10), because of its linear optical structure, for linear quadrilateral illumination, able to create its biaxial light beam with narrow angle in the width-axes and wider angle in the longitudinal-axes, thus it becomes possible to cover a linear quadrilateral illumination area where signed its boundaries well from a single point position. Biaxial light beam created by the Linear TIR Lens (10) illuminates with getting shape of width of the quadrilateral illumination area with narrow angle in the width-axes and illuminates with getting shape of length of the quadrilateral illumination area with wide angle in the longitudinal-axes.

Operating Principle of Linear Hybrid Lens:

Ray Vectors Path in Lateral TIR Structure in Width-axes (25a) occurs in the width-axes of Linear Hybrid Lens' TIR structure creates the narrow angle of the biaxial light beam of the Linear Hybrid Lens (20), rays emitted by the light source refracted into (transition from less dense to dense medium) lateral TIR structure inwardly from the Linear Hybrid Lens Type Ray Collector Lateral Surfaces (22a) in the width-axes, reflected from Linear Hybrid Lens Type Side Surface in Lateral TIR Structure (23) by making the Total Internal Reflection rules in the body to reach the Linear Hybrid Lens Type Ray Diffraction Surface in Lateral TIR Structure (24a), with diffraction (transition from dense medium to less dense) angles in the width-axes from Linear Hybrid Lens Type Ray Diffraction Surface in Lateral TIR Structure (24a) addressed to target quadrilateral illumination area, as well as tracing the longitudinal-axes of Linear Hybrid Lens (20) angle too

Again, Ray Vectors Path in FreeForm Structure in Longitudinal-axes (25b) angle of Linear Hybrid Lens (20) which occur in the FreeForm center structure in the longitudinal-axes of the Linear Hybrid Lens (20); ray vectors emitted by the light source are refracted inwardly from the Linear Hybrid Lens Type Ray Collector Central Surfaces (22b) with respect to the light source and reach to the Linear Hybrid Lens Type Ray Diffraction Surfaces in FreeForm Structure in Longitudinal-axes (24b) of the Linear Hybrid Lens (20) directly with the inward refracting angles only in the lens' body, creating wider angle with outward diffraction angles in the longitudinal-axes, at the same time tracing the Linear Hybrid Lens (20) width-axes, guided to the target linear quadrilateral illumination area.

With using new generation Linear Hybrid Lens (20) type which evolved from TIR and FreeForm structures, it is able to illuminate much longer linear quadrilateral lighting areas (e.g. for road lighting). The new generation Linear Hybrid Lens (20) type mentioned here able to create biaxial light beams with narrow angle in the width-axes and much wider angle in the longitudinal-axes, thus it becomes possible to cover a much longer quadrilateral illumination area from a single point position. New generation Hybrid Lens (20) illuminates with getting shape of width of the quadrilateral illumination area with narrow angle in the width-axes and illuminates with getting shape of length of the quadrilateral illumination area with wide angle in the longitudinal-axis.

Linear Hybrid Lens (20) type creates cut-off solid angle in its TIR structure in the width-axes and creates wider cut-off solid angle in its FreeForm structure in the longitudinal-axes, while creating cut off solid angle in the width-axes also tracing the light beam in the longitudinal-axes and because of this feature switches continuously to the longitudinal-axes cut-off solid angle. With the same way, while creating wider cut off solid angle in the longitudinal-axes also tracing the light beam in the width-axes and with this feature switches continuously to the width-axes cut-off solid angle.

The invention, used in lighting sector, for artificial lighting, is suitable for geometrical shape of the quadrilateral illumination areas especially for covering linear quadrilateral areas with light flux from single point position, has designed based on the Non-imaging optical design technique to get optimal light flux transfer. In its width-axes with using the Total Internal Reflection-TIR optical design technique forms a TIR structure for creating a narrow cut-off angle, also in its longitudinal-axes forms wider structures due to create wider angles, consists of two different structure in its width and longitudinal-axes merging continuously without losing their optical functions to become unit body, takes a linear form with narrow physical form in the width-axes and wider physical form in the longitudinal-axes, creates a narrow cut-off solid angle in its TIR structure in the width-axes and creates wider cut-off angle in the longitudinal-axes, creates cut off solid angle in width-axes while tracing the light beam in longitudinal-axes and because of this feature switches continuously to the longitudinal-axes cut-off solid angle. With the same way, also creates wider cut off solid angle in the longitudinal-axes while tracing the light beam in the width-axes and with this feature switches continuously to the width-axes cut-off solid angle, have biaxial cut-off angled light beam with its narrow angle in the width-axes and wider angle in the longitudinal-axes, illuminates with a sharp enclosed light spotting while marking the width boundaries of the linear quadrilateral target area by its narrow cut-off angle in the width-axes and also marking the longitudinal boundaries of the linear quadrilateral target area by its wider cut-off angle in the longitudinal-axes, illuminates from single point position with a continuous homogenous light dissipation by the sharp enclosed light spottings that determined by getting the shape of target illumination area, minimizes the directional glaring problem with determination of sharp boundary lines by its biaxial cut-off angles, also protects the environment from light pollution, provides a uniform and continuous integrated illumination without leaving a low light interval thanks to modular combination of multiple illuminated areas in the sharp enclosed quadrilateral structure, is a linear lens.

The Linear Lens (10) is formed by narrow TIR structure that creates narrow angle in the width-axes with using Total Internal Reflection-TIR technique, also formed by wider TIR structure for creating wider angle in the longitudinal-axes, emerges with two different structures in width and longitudinal-axes merging continuously without losing their optical functions to become a unit linear TIR body. Again, the Linear TIR Lens (10) comes up with narrow TIR structure in the width-axes and wider TIR structure in the longitudinal-axes merging continuously without losing their optical functions to become unit body. Also Linear Lenses; in the situations where the TIR structures becomes inadequate and requiring wider angles, evolves into FreeForm structure with using FreeForm structure instead of TIR structure in the longitudinal-axes, and the Linear Hybrid Lens (20) comes up with narrow TIR structure in the width-axes and wider structure built in FreeForm style in its longitudinal-axes merging continuously without losing their optical functions to become unit body.

The Linear Lens creates cut-off solid angle in its width-axes and creates wider angled cut-off solid angle in its longitudinal-axes, while creating cut-off solid angle in its width-axes also traces the angle in its longitudinal-axes and because of this feature switches continuously to the longitudinal-axes cut-off solid angle. With the same way, while creating wider cut off solid angle in its longitudinal-axes also traces the narrow solid angle in its width-axes and with this feature switches continuously to its width-axes cut-off solid angle, the Linear Lens have biaxial and cut off angled light beam with its narrow angle in its width-axes and makes wider angle in its longitudinal-axes, illuminates with a sharp enclosed light spotting while marking the width boundaries of the linear quadrilateral target area by its narrow cut-off angle in the width-axes and also marks the longitudinal boundaries of the linear quadrilateral target area by its wider cut-off angle in the longitudinal-axes, covers a linear quadrilateral target area from single point position with a continuous homogenous light dissipation by its sharp enclosed light spottings that determined by cut-off solid angles in both of its width and longitudinal-axes.

1. The invention, used in lighting sector for artificial lighting, suitable for geometrical shape of the quadrilateral illumination areas, especially for covering linear quadrilateral areas with light flux from single point position, is designed based on the Non-imaging optical design technique to get optimal light flux transfer, is essentially characterized by; using the Total Internal Reflection-TIR optical design technique in its width-axes, forming a narrow TIR structure for creating a narrow cut-off solid angle, also in its longitudinal-axes forms wider structures due to create wider solid angles, two different structures in its width and longitudinal-axes merging continuously without losing their optical functions to become a unit body, taking a linear form with narrow physical form in its width-axes and wider physical form in its longitudinal-axes, creating a narrow cut-off solid angle in its TIR structure in its width-axes and creating wider cut-off angle in its longitudinal-axes, while tracing the light beam in longitudinal-axes creating cut off solid angle in its width-axes and because of this feature switches continuously to its longitudinal-axes cut-off solid angle, with the same way, while tracing the light beam in its width-axes also creating wider cut off solid angle in its longitudinal-axes and with this feature switches continuously to the width-axes cut-off solid angle, having biaxial cut-off angled light beam with its narrow angle in its width-axes and wider angle in its longitudinal-axes, illuminating with a sharp enclosed light spotting while marking the width boundaries of the linear quadrilateral target area by its narrow cut-off angle in its width-axes and also marking the longitudinal boundaries of the linear quadrilateral target area by its wider cut-off angle in its longitudinal-axes, illuminating from single point position with a continuous homogenous light dissipation by its sharp enclosed light spottings that determined by getting the shape of target illumination area, minimizing the directional glaring problem with determination of sharp boundary lines by its biaxial cut-off angles, also protecting the environment from light pollution, providing a uniform and continuous integrated illumination without leaving a low light interval thanks to modular combination of multiple illuminated areas in the sharp enclosed quadrilateral structure.

2) Linear Lens specified in claim 1 is essentially characterized in that it comprises; in its width-axes with using the Total Internal Reflection-TIR optical design technique forming a TIR structure for creating a narrow cut-off solid angle, also in longitudinal-axes forming wider TIR structures due to create wider angles, two different structures in width and longitudinal-axes merging in continuously without losing their optical functions to become a unit linear TIR body, Linear TIR Lens (10).

3) Linear Lens specified in claim 1 is essentially characterized in that it comprises; in the situations that the TIR structures in longitudinal-axes becomes inadequate to create wider angles required, evolving into FreeForm structure with using FreeForm style instead of TIR structure in the longitudinal-axes, narrow TIR structure in its width-axes and wider FreeForm structure in its longitudinal-axes merging together continuously without losing their optical functions to become a hybrid unit linear body, Linear Hybrid Lens (20),

4) Linear Lens specified in claim 1 is essentially characterized in that it comprises; while tracing the light beam in longitudinal-axes creating cut off solid angle in its width-axes and because of this feature switches continuously to the longitudinal-axes cut-off solid angle, with the same way, also creating wider cut off solid angle in the longitudinal-axes while tracing the light beam in its width-axes and with this feature switches continuously to its width-axes cut-off solid angle, having biaxial cut-off angled light beam with its narrow angle in the width-axes and wider angle in its longitudinal-axes

5) Linear Lens specified in claim 1 essentially characterized in that it comprises; marking the width boundaries of the linear quadrilateral target area by its narrow cut-off angle in its width-axes and also marking the longitudinal boundaries of the linear quadrilateral target area by its wider cut-off angle in its longitudinal-axes, illuminates from single point position with a continuous homogenous light dissipation by its sharp enclosed light spottings that determined by getting the shape of linear quadrilateral illumination area.

6) Linear Lens specified in claim 4 is essentially characterized in that it comprises; marking the width boundaries of the linear quadrilateral target area by its narrow cut-off angle in its width-axes and also marking the longitudinal boundaries of the linear quadrilateral target area by its wider cut-off angle in its longitudinal-axes, illuminates from single point position with a continuous homogenous light dissipation by its sharp enclosed light spottings that determined by getting the shape of linear quadrilateral illumination area.
